(19) United States
(12) Patent Application Publication
(10) Pub. No.: US 2017/0048305 A1
(43) Pub. Date: Feb. 16, 2017

(54) METHOD, APPARATUS AND COMPUTER-READABLE MEDIUM FOR DISPLAYING MULTIMEDIA INFORMATION IN AN APPLICATION CLIENT

(71) Applicant: Xiaomi Inc., Beijing (CN)

(72) Inventors: Hongjie Liu, Beijing (CN); Hai Long, Beijing (CN); Jun Yuan, Beijing (CN)

(73) Assignee: Xiaomi Inc., Beijing (CN)

(21) Appl. No.: 15/220,101

(22) Filed: Jul. 26, 2016

(30) Foreign Application Priority Data
Aug. 13, 2015 (CN) 201510496923.5

(51) Int. Cl. H04L 29/08; G06F 3/0484; G06F 3/0481

(52) U.S. Cl. CPC H04L 67/10; G06F 3/0481; G06F 3/0484

(57) ABSTRACT

Method, apparatus and computer-readable medium for managing and displaying multimedia information in an application client in an electronic device are disclosed. In one exemplary embodiment, method for centralized management of launching multimedia information into areas within displayed interfaces of multiple application clients running in an electronic device includes determining, by a launch management application client running on the electronic device, multimedia information to be launched to each application client of the multiple application clients based on a predefined launch strategy and a set of multimedia information managed by the launch management application client; and sending the determined multimedia information corresponding to each application client of the multiple application clients, causing each application client, upon reception of the determined multimedia information, to display the determined multimedia information in at least one of the areas of the displayed interface of each application client.

### CROSS-REFERENCE TO RELATED APPLICATION

This application and claims priority to Chinese Patent Application No. 201510496923.5, filed on Aug. 13, 2015, which is incorporated herein by reference in its entirety.

### TECHNICAL FIELD

The present disclosure generally relates to computer technology, and more particularly to a method, apparatus and computer-readable medium for displaying multimedia information.

### BACKGROUND

Applications or application clients may be run in a smart terminal device such as a cell phone and a tablet computer. Displaying tailored advertisements in an application client may be beneficial to the entire ecosystem of advertisers, application service providers, terminal device manufacturers, and users. For example, advertisement may be displayed in a suitable area in the displayed interface of an application client when the application starts up.

Traditionally, an application server associated with an application client is responsible for managing the advertisement multimedia information and launch strategies associated with the application client. For example, the provider of the application server and client may take the initiative of negotiating with advertisers and pre-obtaining a plurality of opening advertisements and set up a launch strategy for selecting suitable advertisements and launching the selected advertisements into running instances of the application client.

Advertisement is only one example of general set of multimedia information that may be launched into an application client.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, a method for centralized management of launching multimedia information into areas within displayed interfaces of multiple application clients running in an electronic device is disclosed. The method comprises: determining, by a launch management application client running on the electronic device, multimedia information to be launched to each application client of the multiple application clients based on a predefined launch strategy and a set of multimedia information managed by the launch management application client; and sending the determined multimedia information corresponding to each application client of the multiple application clients, causing each application client, upon reception of the determined multimedia information, to display the determined multimedia information in at least one of the areas of the displayed interface of each application client.

In another embodiment, a method for displaying multimedia information in multiple application clients in an electronic device is disclosed, comprising: sending a request by each of the multiple application clients to display multimedia information to a launch management application client running in the electronic device upon detection of an occurrence of a predefined event in the application client, wherein the application client corresponds to at least one predefined event and the launch management application client manages launches of multimedia information to the application client; and displaying the multimedia information upon reception of the multimedia information sent by the launch management application client in an area within a displayed interface of each of the multiple application clients.

In another embodiment, a method for centralized management of launching multimedia information from a server into areas within displayed interfaces of multiple application clients running in an electronic device is disclosed, comprising: determining, by the server, multimedia information to be launched to each application client of the multiple application client based on a predefined launch strategy and a set of multimedia information managed by the server; and sending the determined multimedia information corresponding to each application client of the multiple application clients, causing each application client of the multiple application clients, upon reception of the determined multimedia information, to display the corresponding multimedia information in at least one of the areas of the displayed interface of each application client, wherein the server is separate from an application servers associated with the multiple application clients.

In another embodiment, a method for displaying multimedia information in multiple application clients in an electronic device is disclosed, comprising: sending a request by each of the multiple application clients to display multimedia information to a server upon detection of an occurrence of a predefined event in the application client, wherein the application client corresponds to at least one predefined event and the server manages launches of multimedia information to the application client; and displaying the multimedia information upon reception of the multimedia information sent by the server in an area within a displayed interface of each of the multiple application clients.

In another embodiment, an electronic device is disclosed, comprising a memory for storing instructions; a display screen for displaying interfaces for multiple application clients running on the electronic device; and a processor configured to: determine, by a launch management application client running on the electronic device, multimedia information to be launched to each application client of the multiple application clients based on a predefined launch strategy and a set of multimedia information managed by the launch management application client; and send the corresponding determined multimedia information to each application client of the multiple application clients, causing each application client, upon reception of the corresponding multimedia information, to display the corresponding multimedia information in an area of the displayed interface of each application client.

In another embodiment, an electronic device is disclosed, comprising: a memory for storing instructions; a display screen for displaying interfaces of multiple application client running on the electronic device; and a processor configured to: send a request by each of the multiple application clients to display multimedia information to a launch management application client running in the electronic device upon detection of an occurrence of a predefined event in the application client, wherein the application client corresponds to at least one predefined event and the launch management application client manages launches of multimedia information to the application client; and display the multimedia information upon reception of the multimedia information sent by the launch management application client in an area within a displayed interface of each of the multiple application clients.

In another embodiment, a server is disclosed, comprising: a memory for storing instructions; and a processor configured to: determine multimedia information to be launched to each application client of multiple application clients running on an electronic device based on a predefined launch strategy and a set of multimedia information managed by the server; and send the corresponding determined multimedia information to each application client of the multiple application clients, causing each application client of the multiple application clients, upon reception of the corresponding multimedia information, to display the corresponding multimedia information in an area of a displayed interface of each application client, wherein the server is separate from application servers associated with the multiple application clients.

In another embodiment, an electronic device is disclosed, comprising: a memory for storing instructions; a display screen for displaying interfaces of multiple application clients running on the electronic device; and a processor configured to: send a request by each of the multiple application clients to display multimedia information to a server upon detection of an occurrence of a predefined event in the application client, wherein the application client corresponds to at least one predefined event and the server manages launches of multimedia information to the application client; and display the multimedia information upon reception of the multimedia information sent by the server in an area within the displayed interface of each of the multiple application clients.

In another embodiment, a non-transitory computer-readable storage medium comprising instructions stored therein is disclosed. The instruction, when executed by a processor of a computing device, causes the computing device to: determine, by a launch management application client running on an electronic device, multimedia information to be launched to each application client of multiple application clients running on the electronic device based on a predefined launch strategy and a set of multimedia information managed by the launch management application client; and send the corresponding determined multimedia information to each application client of the multiple application clients, causing each application client, upon reception of the corresponding multimedia information, to display the corresponding multimedia information in an area of a displayed interface of each application client.

In another embodiment, a non-transitory computer-readable storage medium comprising instructions stored therein is disclosed. The instruction, when executed by a processor of an electronic device, causes the electronic device to: send a request by each of multiple application clients to display multimedia information to a launch management application client running in the electronic device upon detection of an occurrence of a predefined event in the application client, wherein the application client corresponds to at least one predefined event and the launch management application client manages launches of multimedia information to the application client; and display the multimedia information upon reception of the multimedia information sent by the launch management application client in an area within a displayed interface of each of the multiple application clients.

In another embodiment, a non-transitory computer-readable storage medium comprising instructions stored therein is disclosed. The instruction, when executed by a processor of an electronic device, causes the electronic device to send a request by each of multiple application clients to display multimedia information to a server upon detection of an occurrence of a predefined event in the application client, wherein the application client corresponds to at least one predefined event and the server manages launches of multimedia information to the application client; and display the multimedia information upon reception of the multimedia information sent by the server in an area within a displayed interface of each of the multiple application clients.

### BRIEF DESCRIPTION OF THE DRAWINGS

The accompanying drawings, which are incorporated into and form a part of the specification, illustrate embodiments consistent with the present invention and, together with the disclosure, serve to explain the principles of the invention.

FIG. 1 is a flow diagram illustrating a method for displaying multimedia information according to an exemplary embodiment.

FIG. 2 is a flow diagram illustrating another method for displaying multimedia information according to an exemplary embodiment.

FIG. 3 is a flow diagram illustrating another method for displaying multimedia information according to an exemplary embodiment.

FIG. 4 is a flow diagram illustrating another method for displaying multimedia information according to an exemplary embodiment.

FIG. 5 is a flow diagram illustrating another method for displaying multimedia information according to an exemplary embodiment.

FIG. 6 illustrates a lock screen display interface.

FIG. 7 illustrates a pop-up window display interface.

FIG. 8 illustrates a charging display interface.

FIG. 9A is a block diagram illustrating a system for displaying multimedia information according to an exemplary embodiment.

FIG. 9B illustrates an operation flow diagram according to an exemplary embodiment.

FIG. 10 is a flow diagram illustrating a method for displaying multimedia information according to an exemplary embodiment.

FIG. 11 is a block diagram illustrating an apparatus for displaying multimedia information according to an exemplary embodiment.

FIG. 12 is a block diagram illustrating another apparatus for displaying multimedia information according to an exemplary embodiment.

FIG. 13 is a block diagram illustrating another apparatus for displaying multimedia information according to an exemplary embodiment.

FIG. 14 is a block diagram illustrating another apparatus for displaying multimedia information according to an exemplary embodiment.

FIG. 15 is a block diagram illustrating another apparatus for displaying multimedia information according to an exemplary embodiment.

FIG. 16 is a block diagram illustrating another apparatus for displaying multimedia information according to an exemplary embodiment.

FIG. 17 is a block diagram illustrating another apparatus for displaying multimedia information according to an exemplary embodiment.

FIG. 18 is a block diagram illustrating another apparatus for displaying multimedia information according to an exemplary embodiment.

FIG. 19 is a block diagram illustrating another apparatus for displaying multimedia information according to an exemplary embodiment.

FIG. 20 is a block diagram illustrating an electronic device for displaying multimedia information according to an exemplary embodiment.

FIG. 21 is a block diagram illustrating an electronic equipment for displaying multimedia information according to an exemplary embodiment.

### DETAILED DESCRIPTION

Reference will now be made in detail to exemplary embodiments, examples of which are illustrated in the accompanying drawings. The following description refers to the accompanying drawings in which same numbers in different drawings represent same or similar elements unless otherwise described. The implementations set forth in the following description of exemplary embodiments do not represent all implementations consistent with the invention. Instead, they are merely examples of devices and methods consistent with aspects related to the invention as recited in the appended claims.

Terms used in the disclosure are only for purpose of describing particular embodiments, and are not intended to be limiting. The terms “a”, “said” and “the” used in singular form in the disclosure and appended claims are intended to include a plural form, unless the context explicitly indicates otherwise. It should be understood that the term “and/or” used in the description means and includes any or all combinations of one or more associated and listed terms.

It should be understood that, although the disclosure may use terms such as “first”, “second” and “third” to describe various information, the information should not be limited herein. These terms are only used to distinguish information of the same type from each other. For example, first information may also be referred to as second information, and the second information may also be referred to as the first information, without departing from the scope of the disclosure. Based on context, the word “if” used herein may be interpreted as “when”, or “while”, or “in response to a determination”.

By way of introduction, various applications may run on a terminal device, such as a mobile phone, a tablet, and a laptop computer. Some of these applications may each request and receive services from a corresponding remote application server via communication networks known in the art. All applications running on the terminal device may be referred to as application clients. When an application client is started up in the terminal device, a set of multimedia information, such as advertisements tailored to the user of the application client and the nature of the application client may be downloaded from a corresponding application server and displayed to the user in suitable areas of the displayed interface of the application client. To manage the launch of advertising multimedia information, the service providers operating the application servers may correspondingly negotiate separate economic terms with advertisers, collect advertisement multimedia information from advertisers and send selected and suitable multimedia information for download by application clients upon requests. The selection of suitable and tailored set of multimedia information for each application client may be determined based on a launch strategy maintained for the user by the corresponding application server.

Service providers for various application servers may independently negotiate with a same advertiser providing identical multimedia information. Thus, the independent multimedia information launching management by separate application server may lead to duplicate download of multimedia information to the terminal device. Such a non-centralized advertising scheme is cumbersome and wasteful in network resources and electrical power of terminal devices. In addition, some of the service providers may not have enough users for their application client to interest any advertisers and thus may not be even given opportunity to display advertisement within the application client developed by them.

In some embodiments described below, a special application client, referred to as launch management application client herein, is provided in the terminal device for a centralized management of multimedia information downloading, selection, and launching to other application clients via a centralized launch server. In some other embodiments described below, the application clients communicate directly with the centralized launch server. In all these embodiments, the application clients do not need to interact with individual application servers as to the launching of multimedia information such as advertisement. The disclosed approaches centralizes the management of launch strategies and an overall set of multimedia information via a single launch server, and thus help reduce duplicate data flow, leading to savings in the network resource and power consumption.

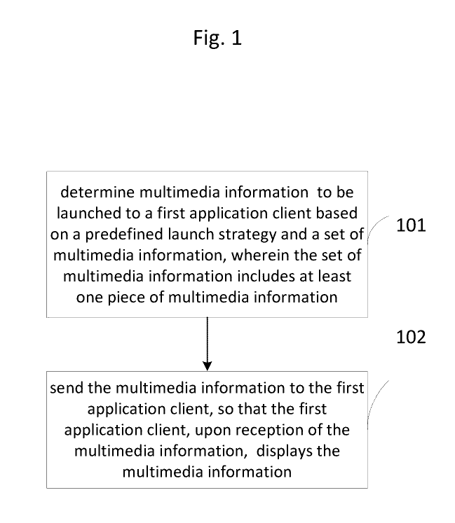

FIG. 1 is a flow diagram illustrating a method for displaying multimedia information according to an exemplary embodiment. The method may be applied to a launch management application client for launching multimedia information to application clients other than the launch management application client itself. In step 101, the launch management application client determines and select which multimedia information is to be launched to a first application client based on a predefined launch strategy and a set of multimedia information, wherein the set of multimedia information includes at least one piece of multimedia information. In step 102, the selected multimedia information is sent to the first application client, causing the first application client, upon reception of the multimedia information, to display the selected multimedia information.

In this embodiment, each installed application client is centrally managed by the launch management application client running on the terminal. The launch management application client predefines the launch strategy and the set of multimedia information. The launch management application client monitors each of the other application clients. Taking the first application client as an example, the launch management application client may determine the multimedia information to be launched to and displayed in the first application client based on the launch strategy and the set of multimedia information. The determined multimedia information is sent to the first application client, so that the first application client, upon reception of the multimedia information, displays the multimedia information. The terminal only needs to download one copy of the launch strategy and the set of multimedia information from, for example, a server for the launch management application client and it is not necessary for each application client to download the multimedia information from the corresponding application server individually. Therefore, duplicate downloading of the same multimedia information may be reduced or avoided.

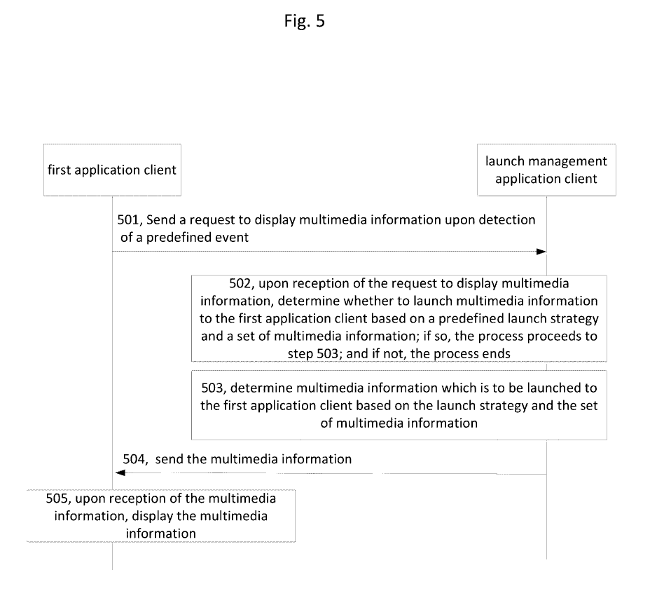

In another exemplary embodiment based on FIG. 1, the method may further include receiving by the launch management application client a request to display multimedia information sent by the first application client currently running on the terminal device before step 101 of determining which multimedia information is to be launched to the first application client based on the predefined launch strategy and the set of multimedia information. The request to display multimedia information is triggered by a predefined event occurred in the first application client (examples of application client and triggering event will be discussed in more detail with reference to FIG. 5).

In another exemplary embodiment based on FIG. 1, the method may further include downloading the launch strategy and the set of multimedia information by communicating with a centralized launch server for the launch management application client via communication networks.

In one implementation of FIG. 1, step 101, determining multimedia information to be launched to the first application client based on the predefined launch strategy and the set of multimedia information may comprise: (1) when the launch strategy includes a list of application clients to which multimedia information could be launched, determining whether the list of application clients includes the first application client; and (2) when the list of application clients includes the first application client, determining the multimedia information to be launched to the first application client based on the launch strategy and the set of multimedia information.

In an alternative implementation, step 101 above (determining the multimedia information to be launched to the first application client based on the predefined launch strategy and the set of multimedia information) may comprise: (1) when the launch strategy includes a launch period of time for the first application client, obtaining a current system time either from the terminal device or from a remote time server; (2) determining whether the system time is within the launch period of time; and (3) when the system time is within the launch period of time, determining the multimedia information which is to be launched to the first application client based on the launch strategy and the set of multimedia information.

In another alternative implementation, step 101 above (determining the multimedia information to be launched to the first application client based on the predefined launch strategy and the set of multimedia information) may comprise: (1) when the launch strategy includes launching multimedia information at a predefined first target total launch frequency, calculating an actual total launch frequency of all application clients based on prior and current launches of multimedia information on the terminal device; and (2) when the calculated actual total launch frequency is less than the predefined first target total launch frequency, determining the multimedia information to be launched to the first application client based on the launch strategy and the set of multimedia information.

In another alternative implementation, step 101 (determining the multimedia information to be launched to the first application client based on the predefined launch strategy and the set of multimedia information) may comprise: when the launch strategy includes specific multimedia information corresponding to the first application client, obtaining the specific multimedia information from the set of multimedia information.

In another alternative implementation, step 101 (determining the multimedia information to be launched to the first application client based on the predetermined launch strategy and the set of multimedia information) may comprise: (1) when the launch strategy includes multiple pieces of specific multimedia information corresponding to the first application client and a set of second predetermined target launch frequencies each corresponding to each piece of the specific multimedia information, obtaining an actual launch frequency for each piece of the multiple pieces of specific multimedia information corresponding to the first application client, wherein the set of predefined second target launch frequencies indicate the target launch frequencies of the corresponding pieces of specific multimedia information; and (2) when the actual launch frequency of a specific piece of the multiple pieces of multimedia information is less than the corresponding second predetermined target launch frequency, determining the specific piece of multimedia information as the multimedia information to be launched to the first application client.

In yet another alternative implementation, step 101 (determining the multimedia information to be launched to the first application client based on the predetermined launch strategy and the set of multimedia information) may comprise: (1) obtaining a current weight of each piece of multimedia information in the set of multimedia information, wherein the weight indicates a probability of a corresponding multimedia information being selected; and (2) selecting the multimedia information to be launched to the first application client from the set of multimedia information in a descending order of the current weight of each piece of multimedia information.

The above technical solutions for step 101 can be combined in any manner to form another alternative implementation.

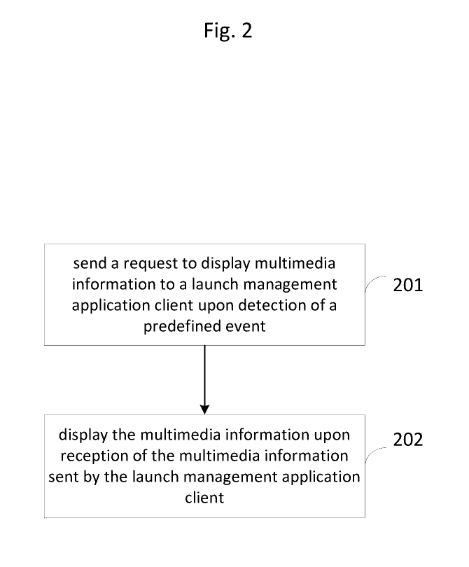

FIG. 2 is a flow diagram illustrating a method for displaying multimedia information according to an exemplary embodiment. This method may be applied to a first application client in communication with a launch management application client. In step 201, a request to display multimedia information is sent to a launch management application client upon detection of a predefined event by the first application client. The first application client corresponds to at least one predefined event (predefined events are described in more detail with respect to FIG. 5 below). The launch management application client is responsible for launching multimedia information to the first application client and other application clients other than the launch management application client itself. In step 202, the multimedia information is displayed upon reception of the multimedia information sent by the launch management application client. In this embodiment, the launch management application client may manage each installed application client centrally, and determine the multimedia information to be launched to the first application client based on the predefined launch strategy and the set of multimedia information, so that the first application client may display the multimedia information. It is not necessary for each application client to download the multimedia information from the corresponding application server for the application client individually, providing savings in network resource and reduction in power consumption for the terminal device.

For example, the first application client may be a lock screen system application and a predefined event corresponding to the lock screen application client may be a screen lock event. For another example, the first application client may be a display application client and a predefined event corresponding to the display application client may be a pop-up window event. As another example, the first application client may be a battery charging application client and a predefined event corresponding to the battery charging application client may be a battery charging event in standby state. More details of the three examples above are discussed with respect to the embodiment of FIG. 5.

Corresponding to the examples above, step 202, displaying the multimedia information, may include: if the first application client is the lock screen application client, displaying the multimedia information on a lock screen interface; or if the first application client is the display application client, displaying the multimedia information on display area in a current scene interface other than the error occupied by the pop-up window; or if the first application client is the battery charging application client, displaying the multimedia information in a battery charging interface (see discussion for FIG. 5 for more details).

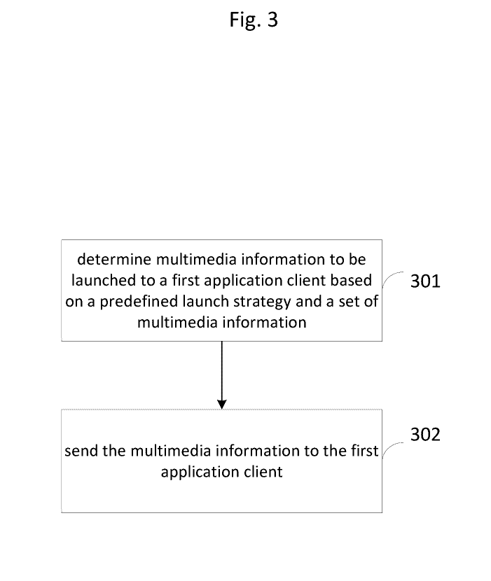

FIG. 3 is a flow diagram illustrating another method for displaying multimedia information according to an exemplary embodiment. As illustrated in FIG. 3, the method for displaying multimedia information is applied to a centralized launch server for launching multimedia information to an application client of a terminal device. The term “centralized” is only meant to be functional. The launch server may include multiple hardware distributed in different locations and yet is still a “central” server in the sense that the distributed hardware components as a whole function to manage the launching of multimedia information to application clients. The server may be remote and communicate with the terminal device via communication networks known in the art. The method includes step 301 and 302. These steps are similar to steps 101 and 102 of FIG. 1, except the launch management application client on the terminal device is replaced with the server. The server of FIG. 3 essentially functions in a similar way as the launch management application client of FIG. 1. The description above for FIG. 1 applies to the embodiment of FIG. 3.

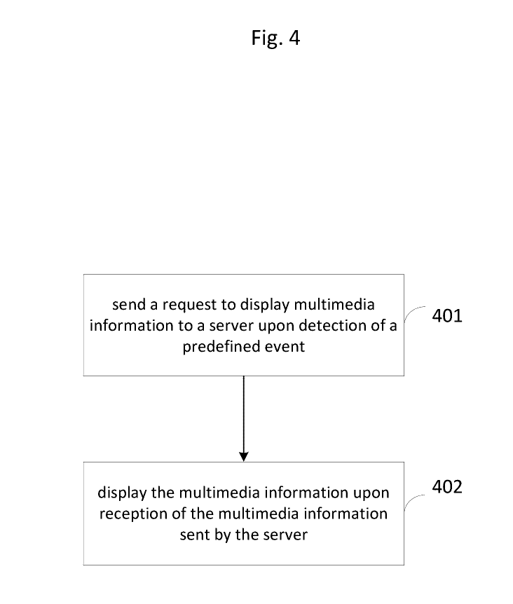

FIG. 4 is a flow diagram illustrating another method for displaying multimedia information according to an exemplary embodiment. As illustrated in FIG. 4, the method for displaying multimedia information is applied to a first application client in communication with a centralized server for managing launches of multimedia information to the first application client. The first application client may communicate with the centralized server via any suitable communication networks. In step 401, a request to display multimedia information is sent to the server upon detection of a predefined event. The first application client corresponds to at least one predefined event, and the centralized server may be responsible for launching multimedia information to an application client of a terminal. In step 402, the multimedia information is displayed in the first application client upon reception of the multimedia information sent by the server.

Thus, in the embodiment of FIG. 4, the server may manage launches of multimedia information in each installed application client centrally, and in particular, determine the multimedia information to be launched to the first application client based on a predefined launch strategy and a set of multimedia information, so that the first application client may display the multimedia information. Thus it is not necessary for each application client to downloading the multimedia information from the application server corresponding to the application server individually and independently, reducing duplicated download of the same multimedia information and saving network resource and power consumption of the terminal.

Exemplary predefined events of FIG. 2, such as the lock screen event, the pop-up window event, and the battery charging event, and their corresponding application clients, are applicable to FIG. 4. Description of these examples can be found in the discussion of FIG. 2 above. Further, more detailed discussion of these examples can be found below with respect to the embodiment of FIG. 5.

FIG. 5 is a flow diagram illustrating a method for displaying multimedia information according to an exemplary embodiment. In this embodiment, the terminal device may be installed with a launch management application client, and may also be installed with at least one other application client. The launch management application client is a special application for managing and multimedia launched in the other application clients. The other application clients may include various kinds of user applications and system processes. User applications, for example, may include but are not limited to a chatting application, a shopping application, and a video player. System processes may include but are not limited to a process for managing battery charging and a process for managing screen locking and unlocking for the terminal. Some application clients, particularly system processes, may be launched by the terminal device's operating system automatically upon system startup. Other application clients may be launched by a user operation, e.g., by clicking an icon of an application client on a mobile phone.

The method of FIG. 5 may be implemented in the launch management application client and a first application client (one of the application clients other than the launch management application client) of the terminal device interacting with one another. Specifically, the launch management application client launches multimedia information selected from a set of multimedia information to the first application client based on a launch strategy.

In step 501, the first application client may send a request to display multimedia information to the launch management application client upon detection of a predefined event. Each application client may independently predefine at least one event. An occurrence of a predefined event of the first application client indicates that the currently displayed interface of the first application client is capable of display multimedia information, such as advertisement. The first application client thus sends a request for multimedia information to the launch management application client upon detection of a predefined event.

A predefined event corresponding to an application client may be defined as an occurrence of a particular configuration of the displayed interface for the application client. For example, an event for the first application client may be defined as an occurrence of blank area in the displayed interface of the first application client. A blank area correspond to an area of the displayed interface of the application client that has not content, i.e., the pixels of the area contains no detectable spatial features. Alternatively or additionally, an event for the first application client may be defined as an occurrence of a display area with information on the displayed interface of the first application client that is redundant with another area. One or more events may be predefined for the first application client (and other application clients). Thus, the contents of the displayed interface of the first application client may be monitored and a detection of any of the predefined display configurations signifies the occurrence of a corresponding event and indicates that the currently displayed interface of the first application client has extra space (e.g., a blank area or an area having redundant information) for multimedia information, such as advertisement. The developer of the first application client may define event in other ways. For example, the first application client may be designed to request multimedia information such as advertisement periodically at regular times. In that case, the system time is monitored and an even is deemed as occurred when the system time matches the predetermined launch time of multimedia information for the first application client.

Other examples of predefined events for some application clients may include lock screen event, pop-up window event and battery charging event under stand-by state. For example, a lock-screen application client for managing screen brightness of the terminal may define a turning-off of the display screen as a lock-screen event. The lock screen application client may detect whether the screen of the terminal is on or off. Upon detection of turning-off of the screen, the lock-screen application client determines that a lock-screen event has occurred and the screen may be used for displaying multimedia information, such as advertisement.

As another example, a display interface managing application client or a menu management application client may define a pop-up event. Upon detection of a pop-up window or pup-up menu, the display interface managing application client or the menu management application client may determine that a pop-up event has occurred indicating that the areas on the display other than the pop-up window or pop-up menu (background to the pop-up window or pop-up menu) may be used for displaying multimedia information such as advertisement.

As yet another example, a battery charging management application client may define a standby battery charging event. When charging the terminal, the battery charging management application client may determine an occurrence of a standby battery charging event when it detects that the battery is being charged in a standby mode, indicating that the display screen of the terminal may be used for displaying multimedia information, such as advertisement.

It should be noted that the predefined events above for application clients are only intended as examples. In practice, other predefined events are possible. The occurrence of any of these events may signify availability of at least a portion of the display screen for displaying multimedia information.

In step 502, upon reception of the request to display multimedia information sent by the first application client, the launch management application client may determine whether to launch multimedia information to the first application client based on a predefined launch strategy and a set of multimedia information. If the determination is positive, the process proceeds to step 503. If the determination is negative, the process ends.

The launch strategy may be designed for managing the display of multimedia information. For example, without limitation, it may manage the display time of multimedia information and or manage the application clients including the first application client for displaying multimedia information. The set of multimedia information may include multiple pieces of multimedia information. In terms of information type, each piece of multimedia information may include at least one of image information, video information, audio information, or webpage link address. In terms of content or subject matter and without limitation, each piece of multimedia information may include contents such as make-up illustrations, clothes, and home goods.

The launch strategy and the set of multimedia information may be determined through negotiation between a launch server associated with the launch management application client and an advertiser producing the multimedia information. The launch server may update the launch strategy and the set of multimedia information. The launch management application client may download the launch strategy and the set of multimedia information from the launch server and save the launch strategy and the set of multimedia information. For example, the launch management application client may download the launch strategy and the set of multimedia information from the launch server via a communication interface with the launch server. The launch management application client may perform the download in real time or periodically. Without limitation, the periodicity for download may be 10 hours or 24 hours.

Alternatively, the launch management application client may perform download upon updating of the launch strategy and the set of multimedia information by the launch server. For example, the launch server may generate version information of the launch strategy and display data files for the set of multimedia information. The version information which may include version name and generation or updating time. The launch management application client may request and obtain version information and determine whether the launch server has more updated launch strategy and data files for the set of multimedia information. The launch management application client may perform downloading from the launch server when there are updated version of the launch strategy and/or the set of multimedia information. The launch management application client may further analyze the received updates and obtain the current launch strategy and set of multimedia information.

In addition, the launch management application client may download the launch strategy and the set of multimedia information simultaneously, or may only download the launch strategy or the set of multimedia information. For example, the launch server may generate a launch strategy file based on the launch strategy and a display information file based on the set of multimedia information. When the launch server updates the launch strategy file, the launch management application client may download the updated launch strategy file from the launch server and analyze the updated launch strategy file to obtain the updated launch strategy. The launch management application client may manage the currently stored set of multimedia information based on the updated launch strategy. Alternatively, after the server has updated the display information file, the launch management application client may download the updated display information file from the server and analyze the updated display information file to obtain the updated set of multimedia information. The launch management application client may manage the updated set of multimedia information based on the currently stored (and previously downloaded and analyzed) launch strategy.

Returning to step 502, upon reception of the request to display multimedia information sent by the first application client, the launch management application client may determine whether to launch multimedia information to the first application client based on the currently stored launch strategy and set of multimedia information. For example, the step 502 may include one or more of the following.

(1) When the launch strategy includes a list of applications to which multimedia information could be launched, it is determined whether the list of applications includes the first application client. If so, the process proceeds to step 503 and if not, the process ends. Specifically, the launch strategy may include the list of applications to which multimedia information may be launched. The list of applications may include a plurality of application clients that allow for displaying multimedia information. The launch management application client may determine whether the list of applications includes the first application client. When the list of applications includes the first application client, it indicates that the first application client allows for displaying multimedia information upon an occurrence of a predefined event for the first application client. Thus the launch management application client may proceed to perform step 503. When the list of applications does not include the first application client, it indicates that the launch management application client is no longer permitted to launches multimedia information to the first application client.

(2) When the launch strategy includes a period of time for launching multimedia information to the first application client, a current system time from either a clock maintained by the terminal device or from a remote time server in communication with the terminal device may be obtained. The launch management application client may determine whether the system time is within the period of time for launching multimedia information to the first application client. If the system time is within the period of time, it indicates that when the predefined event occurs at the current time, the first application client allows for displaying multimedia information. The launch management application client then proceeds to step 503. Otherwise, it indicates that when the predefined event occurs at the current time, the first application client no longer allows for displaying multimedia information, and the launch management application client then ends the process of launching multimedia information to the first application client. The period of time for each application client to launch multimedia information may be specified in the launch strategy as discussed above. Alternatively, it may be part of an event managed by the application client (such that the occurrence of an event is at least partially determined by whether the system time falls within the launch time period). Without limitation, launch periods of time for different application clients may be the same, or may be different. For example, depending on the purpose of application clients, some application clients may allow for multimedia information during mornings while some other application clients may allow for multimedia information only in the evenings.

(3) When the launch strategy includes a first target total launch frequency for multimedia information in the terminal, a total actual launch frequency may be calculated based on prior and current launches of each application client on the terminal, and the launch management application client may determine whether the total actual launch frequency is less than the first target total launch frequency. Specifically, the launch management application client may launch multimedia information to different application clients when different predefined events occur. If the actual launch frequency of the terminal is too high, it may lead to deteriorated user experience. In one implementation, the launch strategy may include a first target launch frequency representing a maximum frequency for launching the multimedia information to the terminal. The launch management application client may maintain a launch record for actual launching of multimedia information to various application clients and use the record to calculate the total actual launch frequency. A calculated total actual launch frequency less than the first target total launch frequency may indicate that the launching of multimedia information is still within the acceptable level for the user and the process proceeds to step 503 to launch multimedia information to the first application client. A calculated total actual launch frequency higher than the first target total launch frequency may indicate that the launching of multimedia information is over the acceptable level for the user and the process ends.

For item (3) above, the total actual launch frequency of the terminal may be represented by the number of display times of multimedia information within a predefined duration. Without limitation, the predefined duration may be determined based on the launch strategy, such as a day and a week. For example, assuming that the predefined duration is a day, when the terminal has displayed in total advertisements 3 times that day, the actual display frequency of the terminal is 3 per day.

It should be noted that the three manners of determination (1)-(3) above are only intended as examples. As long as the first application client or all the application clients (e.g., for item (3)) satisfies any one of the above scenarios, the launch management application client may determine to launch multimedia information to the first application client. In practice, the launch management application client may combine any two or three of the three scenarios in any form to determine whether to launch multimedia information to the first application client. For example, item (1) and (2) may be combined for determining whether to launch multimedia information to the first application client. When the launch strategy includes a list of applications to which multimedia information could be launched, the launch management application client may determine whether the list of application clients includes the first application client. If the list of applications includes the first application client, a launch period of time for the first application client and the current system time may be obtained and compared to determine whether the system time is within the launch period of time. If the system time is within the launch period of time, the launch management application client may determine to launch multimedia information to the first application client and thus proceeds to the step 503. If the list of applications does not include the first application client or the system time is not within the launch period of time for the first application client, the launch management application client does not launch any multimedia information to the first application client.

In addition, the launch management application client may employ other ways to determine whether to launch multimedia information to the first application client, not limited by the implementations above.

In step 503, the launch management application client may determine and select the multimedia information to be launched to the first application client based on the launch strategy and the set of multimedia information. For example, the launch management application client may determine a current weight of each piece of multimedia information in the set of multimedia information, and select the multimedia information to be launched to the first application client from the set of multimedia information in a descending order of the current weight of each piece of multimedia information. When selecting the multimedia information, the launch management application client may select one piece of multimedia information from the set of multimedia information in a descending order of the current weight of each piece of multimedia information, e.g., the multimedia information with the maximum weight. The launch management application client may also select a predefined number of pieces of multimedia information from the set of multimedia information, e.g., a predefined number of pieces of multimedia information with the maximum weights. The predefined number may be determined based on the launch strategy. The predefined numbers associated with different predefined events may be the same or may be different.

The weight of a piece of multimedia information may represent the probability of the piece of multimedia information being selected. The value of the weight of each piece of multimedia information may be in a predefined range, such as (0, 1) or (0, 10) and the like. The sum of the weights of the multiple pieces of multimedia information may be, for example, 1 or another value. The weight of each piece of multimedia information may be determined by the launch management application client based on the launch strategy, or may be updated during operation. For example, when the launch management application client has launched a piece of multimedia information to the first application client, the weight of the multimedia information may be reduced, so that when the predefined event occurs in the first application client, the launch management application client may launch another piece of multimedia information with higher weight instead of the multimedia information with the reduced weight to the first application client. When a piece of multimedia information has not been launched for some predetermined time, the weight of that piece of multimedia information may be increased. By reducing the weight of the multimedia information which has just been launched and increasing the weight of the multimedia information which has not been launched for a while, the various pieces of multimedia information may be launched evenly, thus avoiding favoring some pieces of multimedia information over others.

In addition, when the launch strategy includes a specific piece of multimedia information corresponding to the first application client, the launch management application client may obtain the specific piece of multimedia information corresponding to the first application client from the set of multimedia information and determine the specific piece of multimedia information as the multimedia information to be launched to the first application client.

When the launch strategy includes multiple pieces of specific multimedia information corresponding to the first application client and a second set of predetermined maximum target launch frequencies each for each piece of the specific pieces of multimedia information, the launch management application client may obtain actual launch frequency for each piece of the pieces of specific multimedia information corresponding to the first application client based on the launch record. When the actual launch frequency of the specific piece of multimedia information is less than the corresponding second target launch frequency among the second set of predetermined maximum target launch frequencies, it indicates that the actual frequency in launching the specific piece of multimedia information is not too high and the launch management application client may determine the specific piece of multimedia information as the multimedia information to be launched to the first application client. When the launch frequency is not less than the second target launch frequency of the specific piece of multimedia information, it indicates that the actual frequency in launching the specific piece of multimedia information is too high and the specific multimedia information may not be launched to the first application client.

In step 504, the launch management application client may send the identified multimedia information to the first application client. The launch management application client may package the multimedia information, buttons corresponding to the multimedia information, and the launch strategy of the multimedia information into a View packet, and communicate the packet to the first application client via an inter-process communications interface. The packet may include all necessary information for displaying the multimedia information, such as a background image, a button and other additional information. Upon receiving the packet, the first application client may invoke a standard additive interface AddView to overlay or integrate the packet with the display interface of the first application client.

The multimedia information may be of various formats of information such as image information, video information and audio information. The first application client may determine the format of the multimedia information and submit the multimedia information to a processing module corresponding to the format for rendering the multimedia information. A processing module, for example, may be a decoder for video and a video player software. For example, if the multimedia information is image information, the first application client may submit the image information to a display module to display the image information. If the multimedia information is the video information, the first application client may submit the video information to a video playing module to display the video information.

In step 505, upon reception of the multimedia information, the first application client may display the multimedia information in its display interface. For example, when the multimedia information includes the image information, the first application client may display the image information in its display interface. When the multimedia information is the video information, the first application client may play the video information in its displayed interface.

In one implementation, upon reception of one piece of the multimedia information to be launched, the first application client may display the multimedia information in its currently displayed interface. Upon reception of multiple pieces of the multimedia information to be launched, the first application client may display the multiple pieces of the multimedia information in its currently displayed interface in time sequence or simultaneously. Alternatively, the first application client may divide the multiple pieces of the multimedia information into two or more groups each including multiple pieces of the multimedia information. In its displayed scene, the groups of the multimedia information may be displayed in sequence. The display strategy for the multiple pieces of the multimedia information may be determined based on the launch strategy not limited by the description herein.

The first application client may identify a display area for the multimedia information based on the information being displayed in the current displayed interface and display the multimedia information in the determined display area. For example, the first application client may identify a blank area in the current displayed interface of the first application client for displaying the multimedia information. Alternatively, the first application client may take the entire screen of the displayed interface for the first application client as the display area for displaying the multimedia information as a background of the originally displayed information of the first application client.

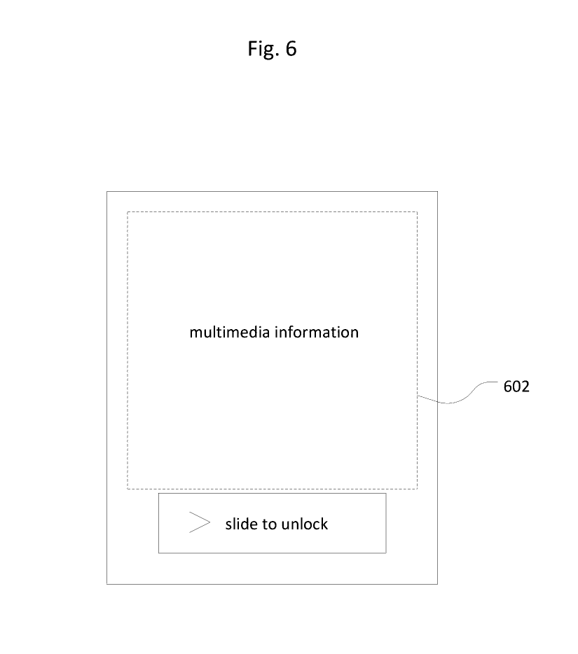

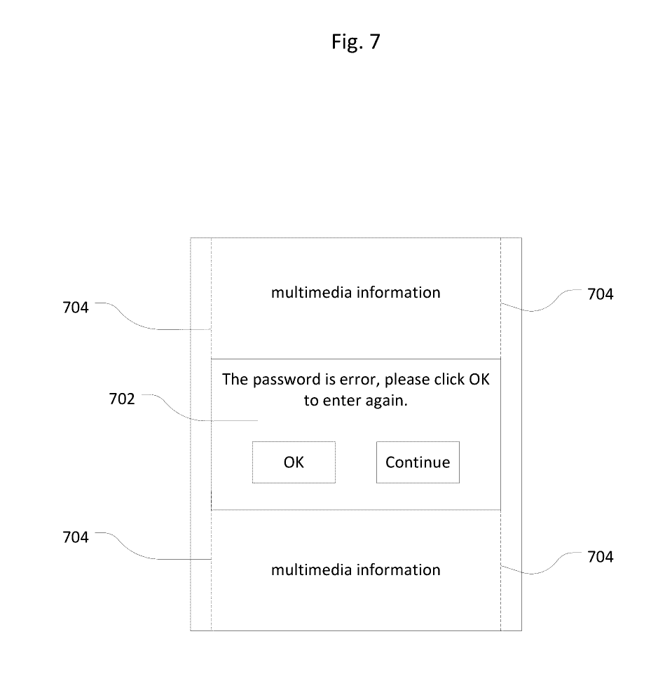

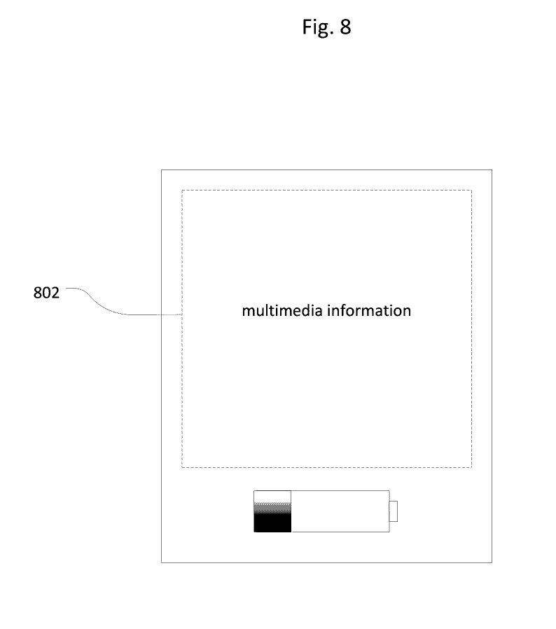

In addition, for different types of predefined events for different first application client, the display areas for the multimedia information may be set in different ways. Referring to FIG. 6, when the predefined event detected by the first application client is the lock screen event, a lock screen interface is displayed and the multimedia information may be displayed in the lock screen interface in the areas indicated by the dashed lines 602 in FIG. 6. Alternatively, referring to FIG. 7, when the predefined event detected by the first application client is the pop-up window event, the display area in which the pop-up window is located is determined as 702 and the multimedia information may be displayed in the display area indicated between the dashed lines 704. Alternatively, referring to FIG. 8, when the predefined event detected by the first application client is the battery charging event in standby state, the first application client may displays a battery charging interface. The display area for the multimedia information may be the area shown by dashed lines 802 in FIG. 8.

When the predefined event ends, the first application client may stop displaying the multimedia information. Taking the above three predefined events as examples, when the lock screen event occurs in the lock screen application client, the multimedia information is displayed on a lock screen interface. But when the lock screen application client detects an operation of unlocking the screen, it may be determined that the lock screen event has ended. Then the lock screen application client may stop displaying the multimedia information. Similarly, when a pop-up window event occurs in the display application client, the multimedia information is displayed in the display area other than the area occupied by the pop-up window. Upon detection of an operation of removing the displayed pop-up window (by closing the pop-up window, for example), the display application client may stop displaying the multimedia information and display the interface being displayed before the window pop-up instead. When a battery charging event in standby state occurs in the battery charging application client, the multimedia information is displayed. Upon detection of a wakeup of the terminal device from standby state, the battery charging application client may stop displaying the multimedia information and display a main interface of the terminal instead. Alternatively, when the charger is unplugged, the battery charging application client may stop displaying the multimedia information and turn off the display screen of the terminal.

When the first application client is displaying the multimedia information, the user may trigger an operation of viewing embedded content of the displayed multimedia information. The operation of viewing may be an operation of clicking the multimedia information or other operations. Upon detection of the operation, the first application client may display a detail page of the multimedia information. When the detail page is closed, the first application client may return to the previous interface and continue to display the multimedia information.

The detail page may include detailed information about the multimedia information. Taking a merchant advertisement as an example, the detailed information may include information about the commodity indicated by the multimedia information, such as brand, price, manufacturer and the like. The detail page may be pre-downloaded from the launch server by the launch management application client, or may be downloaded from a server corresponding to the multimedia information by the first application client. For example, if the multimedia information is a webpage link address, the first application client may send an access request to a server corresponding to the webpage link address and receive a webpage returned from that server which is the detail page of the multimedia information.

When the first application client is displaying the multimedia information, the user may trigger an operation to share the multimedia information. For example, the interface may include a button for sharing, and the operation of sharing may be the operation of clicking the button. Upon detection of the operation to share the multimedia information (such as a click of the button), the first application client may send a request for sharing the multimedia information to a server. This server may be the launch server, or some other servers. After receiving the request for sharing, the server may issue a message containing the multimedia information or a link to the multimedia information to the user's fiends. The contact information of the friends may be kept in the server in an account belonging to the user or it may be passed to the server by filling out a box in the displayed interface of the multimedia information. The friends of the user of the first application client may view the message from the server. Further, after sending the request for sharing, the first application client may return to the current interface and continue to display the multimedia information.

In addition, after the first application client completes displaying the multimedia information, the launch management application client may update the launch record by adding the multimedia information to the launch record. The launch management application client may also add to the launch record the time when the first application client displayed the multimedia information, the operation triggered by the user to the multimedia information and the like. Then the launch management application client may send the launch record to the launch server. The launch record is then stored by the launch server.

Further, after the launch management application client downloads the launch strategy and the set of multimedia information from the launch server, the multimedia information may be displayed and the launch record may be generated in case the launch server is disconnected. The above process may be performed offline without connecting to the network. When the network connection with the launch server is recovered, the launch management application client may send the launch record to the server.

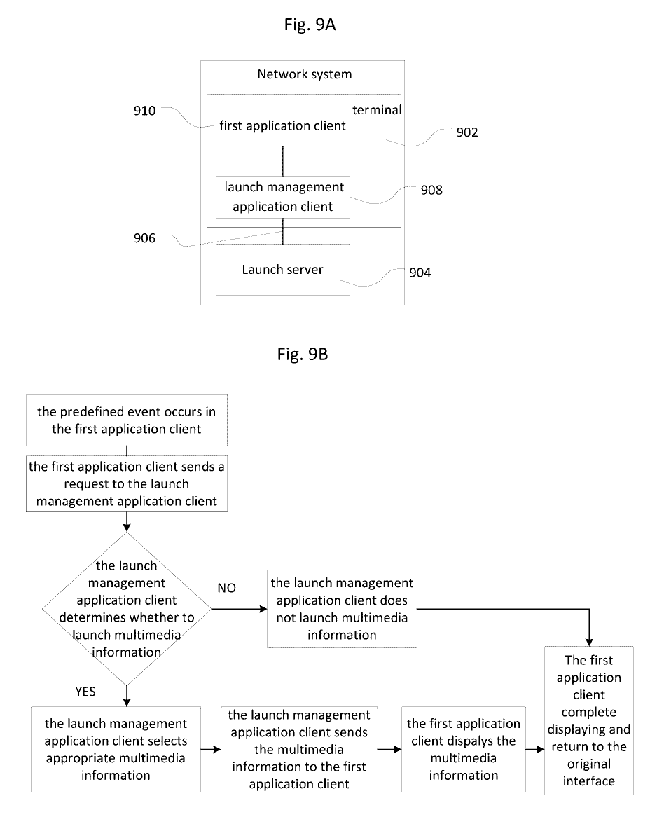

FIG. 9A is a block diagram of a network system including a terminal 902 and a launch server 904 serving for the terminal. The terminal and the server are connected with a network connection 906. The launch server may set up a launch strategy and obtain a set of multimedia information. The terminal may run a launch management application client 908 which may download the launch strategy and the set of multimedia information from the launch server. When a predefined event occurs in a first application client 910, the launch management application client 908 may launch multimedia information to the first application client 910 based on the launch strategy and the set of multimedia information. The multimedia information may be displayed by the first application client. The operation flow of the launch management application client may be shown in FIG. 9B.

In the embodiments above, the launch management application client may centralize the management of launching of multimedia information in application clients based on the predefined launch strategy and the set of multimedia information. It is not necessary for each application client to download the multimedia information from an application server corresponding to the application client individually or independently, avoiding downloading duplicate multimedia information and providing savings in network resource and power consumption. By launching the multimedia information to each application client when a corresponding predefined event occurs rather than launching the multimedia information only when the application client is started up, exposure of the multimedia information such as advertisement to the user is expanded.

In related arts, multiple application servers are configured with launch strategies individually, and each application client downloads advertisement resource from corresponding application server individually. Thus in the related arts, a service provider of an application needs to negotiate with an advertiser individually based on its own requirements. The advertiser may determine whether to provide advertisement information based economic information such as the number of the current users of the application client. Once the advertiser determines to provide advertisement launch service to the application client, the application server managed by the application service provider needs to integrate packets of the advertisement multimedia information provided by the advertiser and set up launch strategies to manage the multimedia information. Multiple application service providers may work with a same advertiser and each of them may be managing a set of same multimedia information. In addition, each application client on the terminal needs to communicate with separate application servers to obtain the multimedia information such as advertisements. Further, some application clients with few users may not be able to find the appropriate advertiser for launching advertisement to them.

However, the multimedia launching system of the embodiments of this disclosure may include the terminal device and one launch server. The terminal may run the launch management application client which only needs to download one copy of the launch strategy and the advertisement resource from the launch server to launch advertisement to different application clients, thus achieving a centralized management for multiple application clients. The launch management application client may also update the launch strategy and the advertisement resource by obtaining version information from the launch server regularly. In addition, it is not necessary for each application client to download the advertisement resource from the application server individually, and thus duplicate downloading of the same advertisement resource may be avoided and network resource and power consumption may be saved. The launch management application client may also provide the corresponding launch strategy, such as time period control strategy, frequency control strategy and so on, and may be responsible for the overall user experience of the terminal. The launch server associated with the launch management application client only needs to be configured with one copy of the launch strategy and the advertisement resource, while the various application servers do not need to be configured with the launch strategy and the advertisement resources, simplifying the operation of the application servers.

A system-level advertisement display platform is provided for the terminal device in the present disclosure. The manufacturer of the terminal rather than each individual application developer may negotiate with the advertiser to display an appropriate advertisement automatically in an application client when a predefined event occurs. This does not depend on the number of users of the application client, as long as the advertiser has negotiated with the producer of the terminal for all application clients as a whole. The single central launch server communicating with the launch management application client may be provided by the terminal manufacturer. The application servers need not to manage any launching strategies or multimedia advertisement or other information. In addition, the application servers need not to communicate with individual application clients regularly yet still achieve display of advertisement upon occurrence of predefined events rather than only displaying advertisement upon start-up of the application clients.

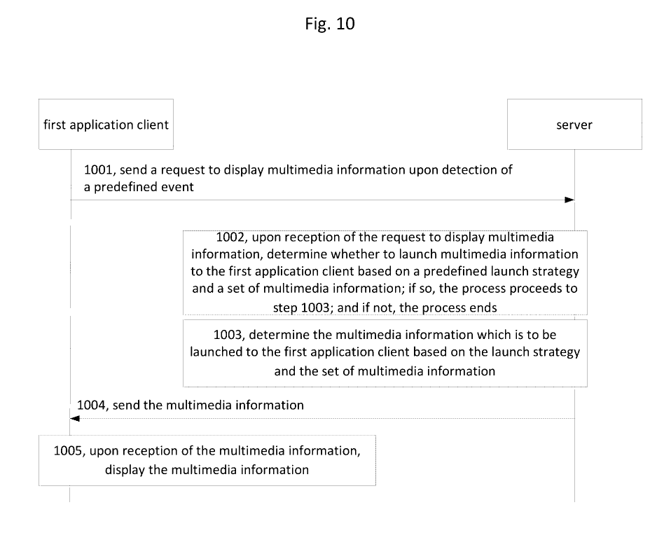

The method of FIG. 5 involves the application client and the launch manage application client with the latter in communication with the launch server. FIG. 10 is a flow diagram illustrating another method for displaying multimedia information according to an exemplary embodiment. As illustrated in FIG. 10, the application clients may directly communicate with the centralized launch server rather than via a launch management application client installed on the terminal device. In step 1001, a first application client may send a request to display multimedia information to the launch server upon detection of a predefined event. The launch server is associated with various application clients installed on the terminal device for launching multimedia information to the various application clients. In step 1002, upon reception of the request to display multimedia information sent by the first application client, the launch server may determine whether to launch multimedia information to the first application client based on a predefined launch strategy and a set of multimedia information. If so, the process proceeds to step 1003; and if not, the process ends. In step 1003, the launch server may determine the multimedia information to be launched to the first application client based on the launch strategy and the set of multimedia information. In step 1004, the launch server may send the multimedia information in the form of data packets to the first application client. In step 1005, upon reception of the multimedia information, the first application client may display the multimedia information. The steps 1001-1005 are similar with the steps 501-505 except that the launch application management client is replaced by the launch server and the communication between the application client and the launch server may be via network communications rather than inter-process communication interfaces within the terminal device.

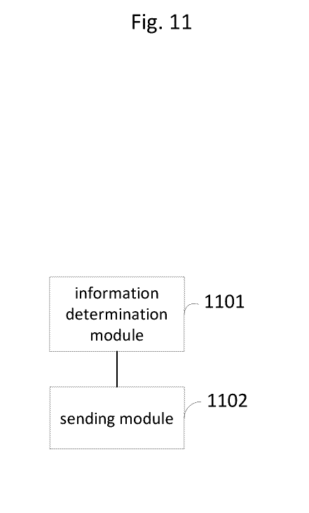

FIG. 11 is a block diagram illustrating an apparatus for displaying multimedia information according to an exemplary embodiment. As illustrated in FIG. 11, the apparatus is applied to a launch management application client for launching multimedia information to other application clients than the launch management application client. The apparatus may include an information determination module 1101 and a sending module 1102. The information determination module 1101 is configured to determine and identify multimedia information to be launched to a first application client based on a predefined launch strategy and a set of multimedia information, wherein the set of multimedia information includes at least one piece of multimedia information. The sending module 1102 is configured to send the multimedia information to the first application client, so that the first application client displays the received multimedia information.

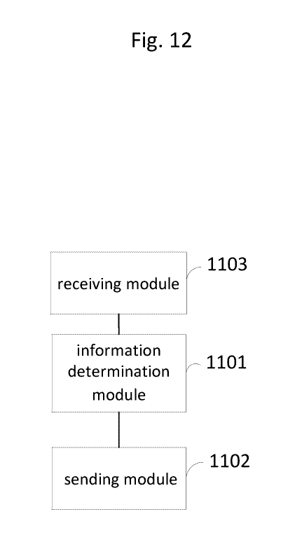

FIG. 12 shows an exemplary embodiment based on FIG. 11. The apparatus further includes a receiving module 1103 configured to receive a request to display multimedia information sent by the first application client, wherein the request to display multimedia information is triggered by an occurrence of a predefined event in the first application client.

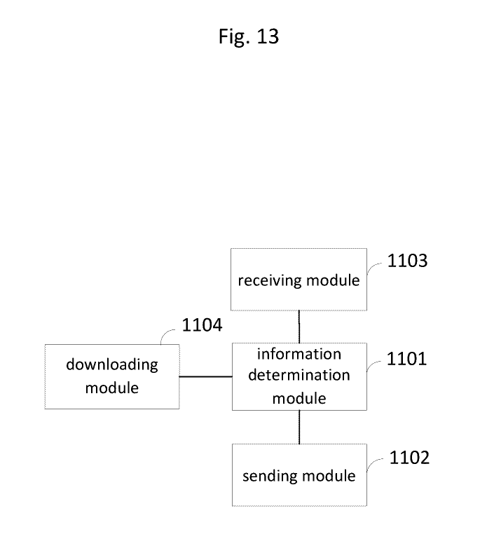

FIG. 13 illustrates an exemplary embodiment based on FIG. 12, the apparatus further includes a downloading module 1104 configured to download the launch strategy and the set of multimedia information from a central launch server.

In an exemplary implementation of the information determination module 1101, the module 1101 is configured to determine whether a list of applications allowing for launching of multimedia information within the launch strategy includes the first application client and if so, determine and identify the multimedia information to be launched to the first application client based on the launch strategy and the set of multimedia information.

In another exemplary implementation of the information determination module 1101, the module 1101 is configured to obtain a current system time and determine whether the system time is within a launch period of time specified the launch strategy for the first application client, and if so, determine and identify the multimedia information to be launched to the first application client based on the launch strategy and the set of multimedia information.

In another exemplary implementation of the information determination module 1101, module 1101 is configured to calculate a total launch frequency based on launch frequency of each application client on a terminal and determine whether the calculated total launch frequency is lower than a first target launch frequency specified in the launch strategy, and if so, determine and identify the multimedia information to be launched to the first application client based on the launch strategy and the set of multimedia information.

In another exemplary implementation of the information determination module 1101, the module 1101 is configured to obtain a specific piece of multimedia information corresponding to the first application client from the set of multimedia information when the launch strategy has so specified.

In another exemplary implementation of the information determination module 1101, module 1101 is configured to: when the launch strategy includes multiple pieces of specified multimedia information corresponding to the first application client and a second launch frequency of each piece of specified multimedia information, obtain launch frequency for each piece of specified multimedia information corresponding to the first application client, wherein the second launch frequency indicates the launch frequency of the corresponding specified multimedia information; and when the launch frequency of the specified multimedia information is less than the corresponding second launch frequency, determine the specified multimedia information as the multimedia information which is to be launched to the first application client.

In another exemplary implementation of the information determination module 1101, the module 1101 is configured to: obtain a current weight of each piece of multimedia information in the set of multimedia information, wherein the weight indicates a probability of a corresponding multimedia information being selected; and select the multimedia information which is to be launched to the first application client from the set of multimedia information in a descending order of the current weight of each piece of multimedia information.

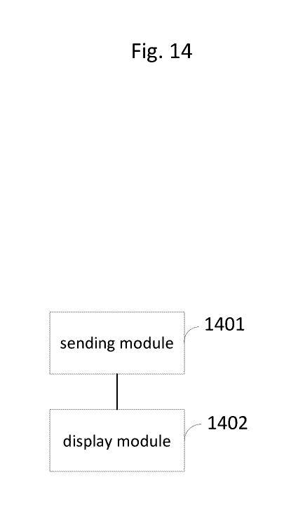

FIG. 14 is a block diagram illustrating an apparatus for displaying multimedia information according to an exemplary embodiment. As illustrated in FIG. 14, the apparatus is applied to a first application client. The apparatus may include a sending module 1401 and a display module 1402. The sending module 1401 is configured to send a request to display multimedia information to a launch management application client upon detection of a predefined event, wherein the first application client corresponds to at least one predefined event, and the launch management application client launches multimedia information to other application clients than the launch management application client. The display module 1402 is configured to display the multimedia information upon reception of the multimedia information sent by the launch management application client.

In the apparatus provided in this embodiment, the launch management application client may manage each installed application client centrally, and determine the multimedia information to be launched to the first application client based on the predefined launch strategy and the set of multimedia information, so that the first application client may display the multimedia information. It is not necessary for each application client to download the multimedia information from an application server individually, therefore duplicate downloads may be avoided, providing savings in network resource and power consumption.

In an exemplary embodiment, the predefined event corresponding to a lock screen application client includes a lock screen event; the predefined event corresponding to a display application client includes a pop-up window event; and the predefined event corresponding to a battery charging application client includes a battery charging event in standby state.

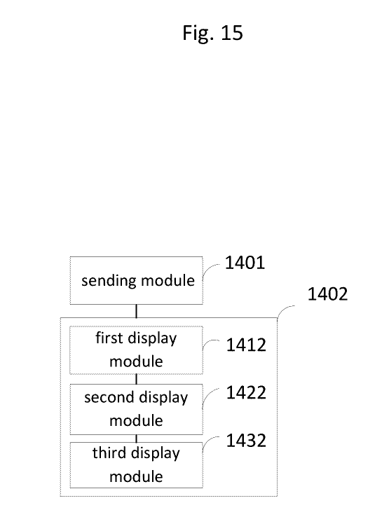

Referring to FIG. 15, an exemplary implementation of the display module 1402 may include a first display module 1412 configured to display the multimedia information on a lock screen interface if the first application client is the lock screen application client; or a second display module 1422 configured to display the multimedia information on display area in a currently displayed interface outside the pop-up window if the first application client is the display application client; or a third display module 1432 configured to display the multimedia information in a battery charging interface if the first application client is the battery charging application client.

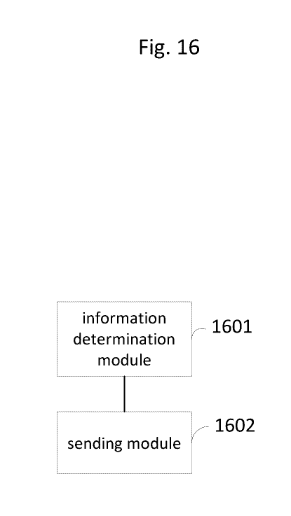

FIG. 16 is a block diagram illustrating an apparatus for displaying multimedia information according to an exemplary embodiment. As illustrated in FIG. 16, the apparatus is applied to a launch server for launching the multimedia information to an application client of a terminal. The apparatus may include an information determination module 1601 and a sending module 1602. The information determination module 1601 is configured to determine and identify multimedia information to be launched to a first application client based on a predefined launch strategy and a set of multimedia information, wherein the set of multimedia information includes at least one piece of multimedia information. The sending module 1602 is configured to send the multimedia information to the first application client, so that the first application client, upon reception of the multimedia information, displays the multimedia information.

In the apparatus provided in this embodiment, the launch server may manage each application client installed on the terminal, and determine the multimedia information which is to be launched to the first application client based on the predefined launch strategy and the set of multimedia information, so that the first application client may display the multimedia information. It is not necessary for each application client to download the multimedia information from an application server individually. Thus, duplicate downloading of the same multimedia information may be avoided, providing savings in network resource and power consumption of the terminal.

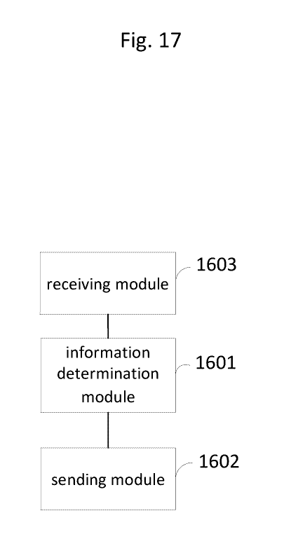

FIG. 17 illustrates an exemplary embodiment based on FIG. 16. The apparatus may further include: a receiving module 1603 configured to receive a request to display multimedia information sent by the first application client, wherein the request to display multimedia information is triggered by an occurrence of a predefined event in the first application client.

In an exemplary implementation of the information determination module 1601, module 1601 is configured to: when the launch strategy includes a list of applications to which multimedia information should be launched, determine whether the list of applications includes the first application client; and when the list of applications includes the first application client, determine the multimedia information which is to be launched to the first application client based on the launch strategy and the set of multimedia information.

In another exemplary implementation of the information determination module 1601, module 1601 is configured to: when the launch strategy includes a launch period of time for the first application client, obtain a current system time indicated by a clock; determine whether the system time is in the launch period of time; and when the system time is in the launch period of time, determine the multimedia information which is to be launched to the first application client based on the launch strategy and the set of multimedia information.

In another exemplary implementation of the information determination module 1601, module 1601 is configured to: when the launch strategy includes a first launch frequency, calculate a total launch frequency based on launch frequency of each application client on the terminal, wherein the first launch frequency indicates launch frequency of the terminal; and when the total launch frequency is less than the first launch frequency, determine the multimedia information which is to be launched to the first application client based on the launch strategy and the set of multimedia information.

In another exemplary implementation of the information determination module 1601, module 1601 is configured to: when the launch strategy includes specified multimedia information corresponding to the first application client, obtain the specified multimedia information corresponding to the first application client from the set of multimedia information.

In another exemplary implementation of the information determination module 1601, module 1601 is configured to: when the launch strategy includes multiple pieces of specified multimedia information corresponding to the first application client and a second launch frequency of each piece of specified multimedia information, obtain launch frequency for each piece of specified multimedia information corresponding to the first application client, wherein the second launch frequency indicates the launch frequency of the corresponding specified multimedia information; and when the launch frequency of the specified multimedia information is less than the corresponding second launch frequency, determine the specified multimedia information as the multimedia information which is to be launched to the first application client.

In yet another exemplary implementation of the information determination module 1601, module 1601 is configured to: obtain a current weight of each piece of multimedia information in the set of multimedia information, wherein the weight indicates a probability of a corresponding multimedia information being selected; and select the multimedia information which is to be launched to the first application client from the set of multimedia information in a descending order of the current weight of each piece of multimedia information.

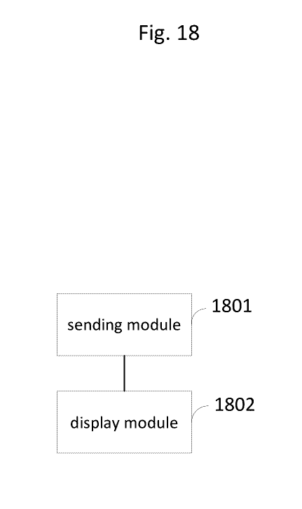

FIG. 18 is a block diagram illustrating an apparatus for displaying multimedia information according to an exemplary embodiment. As illustrated in FIG. 18, the apparatus is applied to a first application client. The apparatus may include a sending module 1801 and a display module 1802. The sending module 1801 is configured to send a request to display multimedia information to a central launch server upon detection of a predefined event, wherein the first application client corresponds to at least one predefined event, and the central launch server launches multimedia information to an application client of a terminal. The display module 1802 is configured to display the multimedia information upon reception of the multimedia information sent by the server. The apparatus of FIG. 18 is similar to that of FIG. 14, except that the launch management application client is replaced by the central launch server. The relevant description in FIG. 14 applies to FIG. 18.

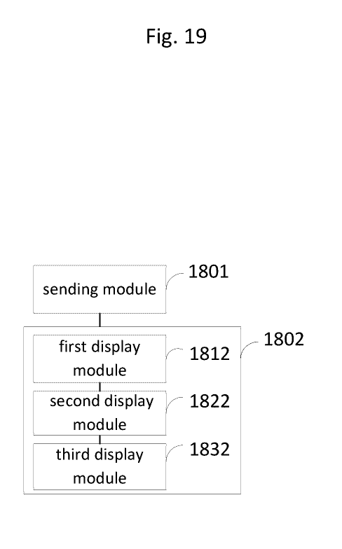

FIG. 19 in an exemplary implementation of the display module 1802. FIG. 19 is similar to FIG. 15 except that the launch management application client is replaced by the central launch server. The relevant description in FIG. 15 applies to FIG. 19.

With respect to the apparatus in the above described embodiments, the way in which each module operates has been described in detail in embodiments of the corresponding method and will not be described here.

It should be noted that when the apparatus for displaying multimedia information provided in the above described embodiments displays the multimedia information, the division of the above described modules is only an example. In practice, the above described functions may be distributed to different modules as required, that is to say, the terminal and the server may be divided into different modules, to achieve part or all of the above described functions. In addition, the method and the apparatus for displaying multimedia information provided in the embodiments belong to a same concept, the detailed implementation of which may be referred to the method embodiments and will not described here.

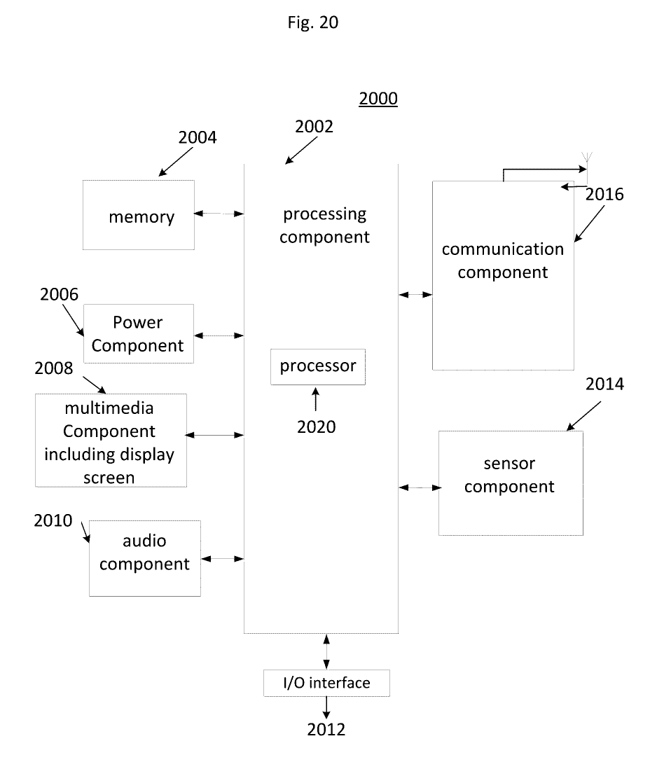

FIG. 20 is a block diagram of an apparatus 2000 for displaying multimedia information according to an exemplary embodiment. For example, the apparatus 2000 may be a mobile phone, a computer, a digital broadcast terminal, a messaging device, a gaming console, a tablet, a medical device, exercise equipment, a personal digital assistant and the like.

Referring to FIG. 20, the apparatus 2000 may include one or more of the following components: a processing component 2002, a memory 2004, a power component 2006, a multimedia component 2008, an audio component 2010, an input/output (I/O) interface 2012, a sensor component 2014, and a communication component 2016.

The processing component 2002 controls overall operations of the apparatus 2000, such as the operations associated with display, telephone calls, data communications, camera operations, and recording operations. The processing component 2002 may include one or more processors 2020 to execute instructions to perform all or part of the steps in the above described methods. Moreover, the processing component 2002 may include one or more modules which facilitate the interaction between the processing component 2002 and other components. For instance, the processing component 2002 may include a multimedia module to facilitate the interaction between the multimedia component 2008 and the processing component 2002.

The memory 2004 is configured to store various types of data to support the operation of the apparatus 2000. Examples of such data include instructions for any applications or methods operated on the apparatus 2000, contact data, phonebook data, messages, pictures, video, etc. The memory 2004 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 2006 provides power to various components of the apparatus 2000. The power component 2006 may include a power management system, one or more power sources, and any other components associated with the generation, management, and distribution of power for the apparatus 2000.

The multimedia component 2008 includes a display screen providing an output interface between the apparatus 2000 and the user. In some embodiments, the screen may include a liquid crystal display (LCD) and a touch panel (TP). The display screen may be used to display the interface for an application client running on apparatus 2000. If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 2008 includes a front camera and/or a rear camera. The front camera and the rear camera may receive an external multimedia data while the apparatus 2000 is in an operation mode, such as a photographing mode or a video mode. Each of the front camera and the rear camera may be a fixed optical lens system or have optical focusing and zooming capability.

The audio component 2010 is configured to output and/or input audio signals. For example, the audio component 2010 may include a microphone (“MIC”) configured to receive an external audio signal when the apparatus 2000 is in an operation mode, such as a call mode, a recording mode, and a voice recognition mode. The received audio signal may be further stored in the memory 2004 or transmitted via the communication component 2016. In some embodiments, the audio component 2010 further includes a speaker to output audio signals.

The I/O interface 2012 provides an interface between the processing component 2002 and peripheral interface modules, the peripheral interface modules being, for example, a keyboard, a click wheel, buttons, and the like. The buttons may include, but are not limited to, a home button, a volume button, a starting button, and a locking button.

The sensor component 2014 includes one or more sensors to provide status assessments of various aspects of the apparatus 2000. For instance, the sensor component 2014 may detect an open/closed status of the apparatus 2000, relative positioning of components (e.g., the display and the keypad, of the apparatus 2000), a change in position of the apparatus 2000 or a component of the apparatus 2000, a presence or absence of user contact with the apparatus 2000, an orientation or an acceleration/deceleration of the apparatus 2000, and a change in temperature of the apparatus 2000. The sensor component 2014 may include a proximity sensor configured to detect the presence of a nearby object without any physical contact. The sensor component 2014 may also include a light sensor, such as a CMOS or CCD image sensor, for use in imaging applications. In some embodiments, the sensor component 2014 may also include an accelerometer sensor, a gyroscope sensor, a magnetic sensor, a pressure sensor, or a temperature sensor or thermometer.

The communication component 2016 is configured to facilitate communication, wired or wirelessly, between the apparatus 2000 and other devices. The apparatus 2000 can access a wireless network based on a communication standard, such as WiFi, 2G, 3G, LTE, or 4G cellular technologies, or a combination thereof. In an exemplary embodiment, the communication component 2016 receives a broadcast signal or broadcast associated information from an external broadcast management system via a broadcast channel. In an exemplary embodiment, the communication component 2016 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 2000 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In another exemplary embodiment, a non-transitory computer-readable storage medium is provided. The storage medium includes instructions, when executable by the processor 2020 in the apparatus 2000, perform the above-described methods. The non-transitory computer-readable storage medium may be a ROM, a RAM, a CD-ROM, a magnetic tape, a floppy disc, an optical data storage device, and the like.

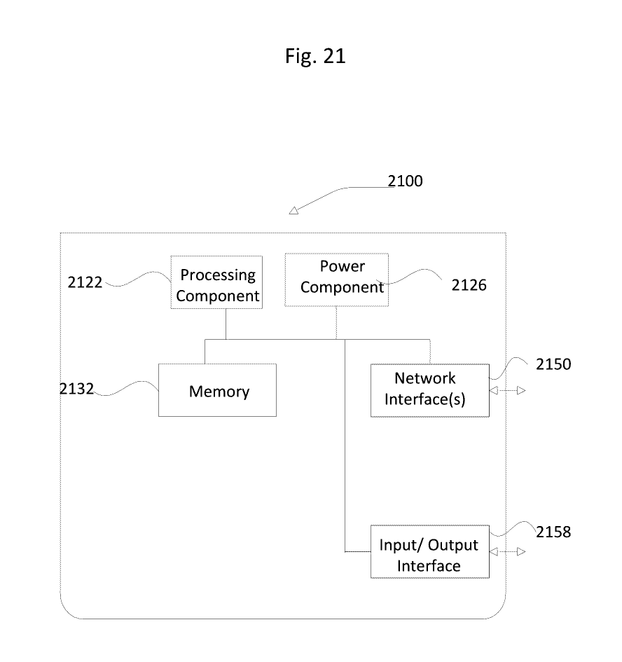

FIG. 21 is a block diagram of an apparatus 2100 for displaying multimedia information according to an exemplary embodiment. For example, the apparatus 2100 may be a server. Referring to FIG. 21, the apparatus 2100 may include a processing component 2122 (e.g. one or more processors), a memory 2132 for storing instructions (e.g. application programs) executable by the processing component 2122. The application programs stored in the memory 2132 may include one or more modules. Each module may include a set of instructions. Further, the processing component 2122 may be configured to execute the sets of instructions and perform the method for displaying multimedia information described above.

The apparatus 2100 may also include a power supply 2126 configured to perform power management for the apparatus 2100, a wired or wireless network interfaces 2150 configured to connect the apparatus 2100 to the network, an input/output interfaces 2158. The apparatus 2100 may operate based on an operating system stored in the memory 2132, such as Windows Server, Mac OS X™, Unix™, Linux™ FreeBSD™, or the like.

Each module or unit discussed above for FIG. 11-19, such as the information determination module, the sending module, the receiving module, the downloading module, the display module, the first display module, the second display module, and the third display module may take the form of a packaged functional hardware unit designed for use with other components, a portion of a program code (e.g., software or firmware) executable by the processor 2020 or the processing circuitry that usually performs a particular function of related functions, or a self-contained hardware or software component that interfaces with a larger system, for example.

The illustrations of the embodiments described herein are intended to provide a general understanding of the structure of the various embodiments. The illustrations are not intended to serve as a complete description of all of the elements and features of apparatus and systems that utilize the structures or methods described herein. Other embodiments of the disclosure will be apparent to those skilled in the art from consideration of the specification and practice of the embodiments disclosed herein. This application is intended to cover any variations, uses, or adaptations of the disclosure following the general principles thereof and including such departures from the present disclosure as come within known or customary practice in the art. It is intended that the specification and examples are considered as exemplary only, with a true scope and spirit of the invention being indicated by the following claims in addition to the disclosure.

It will be appreciated that the inventive concept is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for centralized management of launching multimedia information into areas within displayed interfaces of multiple application clients running in an electronic device, comprising:
determining, by a launch management application client running on the electronic device, multimedia information to be launched to each application client of the multiple application clients based on a predefined launch strategy and a set of multimedia information managed by the launch management application client; and
sending the determined multimedia information corresponding to each application client of the multiple application clients, causing each application client, upon reception of the determined multimedia information, to display the determined multimedia information in at least one of the areas of the displayed interface of each application client.

2. The method of claim 1, further comprising:
receiving, by the launch management application client, requests to display multimedia information sent by the multiple application clients before determining multimedia information to be launched to each of the multiple application clients, wherein each request to display multimedia information is triggered by an occurrence of a predefined event in one of the multiple application clients.

3. The method of claim 1, further comprising downloading, by the launch management application client, the launch strategy and the set of multimedia information from a server, wherein the server is separate from multiple application servers associated with the multiple application clients.

4. The method of claim 1, wherein determining the multimedia information for each application client comprises determining, in response to a preset data state, the multimedia information to be launched to the application client based on the launch strategy and the set of multimedia information, wherein the preset data state comprises:
when the launch strategy comprises a list of application clients to which multimedia information could be launched and the list includes the application client; or
when a system time is within a launch time period included in the launch strategy for the application client; or
when an actual total launch frequency of multimedia information for all the multiple application clients is less than a first total maximum launch frequency preset in the launch strategy.

5. The method of claim 1, wherein determining the multimedia information to be launched to each application client based on the predefined launch strategy and the set of multimedia information comprises:
determining, when the launch strategy comprises specific multimedia information corresponding to the application client, the specific multimedia information from the set of multimedia information as the multimedia information to be launched to the application client; or
obtaining, when the launch strategy comprises multiple pieces of the specific multimedia information and a second maximum launch frequencies each for each of the pieces of the specific multimedia information, an actual launch frequency for each piece of specific multimedia information, wherein the second maximum launch frequency indicates a maximum tolerable launch frequency of the piece of specific multimedia information, and selecting, when the actual launch frequency of the piece of specific multimedia information is less than the corresponding second maximum launch frequency, the specific piece of multimedia information to be the multimedia information to be launched to the application client; or
obtaining a current weight of each piece of multimedia information in the set of multimedia information, wherein the weight indicates a probability of a corresponding multimedia information being selected, and selecting the multimedia information to be launched to the application client from the set of multimedia information in a descending order of the current weight of each piece of multimedia information.

6. A method for displaying multimedia information in multiple application clients in an electronic device, comprising:
sending a request by each of the multiple application clients to display multimedia information to a launch management application client running in the electronic device or a server upon detection of an occurrence of a predefined event in the application client, wherein the application client corresponds to at least one predefined event and the launch management application client or the server manages launches of multimedia information to the application client; and
displaying the multimedia information upon reception of the multimedia information sent by the launch management application client or the server in an area within a displayed interface of each of the multiple application clients.

7. The method of claim 6, wherein,
the multiple application clients comprise a lock screen application and the predefined event corresponding to the lock screen application client comprises a screen locking event;
the multiple application clients comprise a display application and the predefined event corresponding to the display application client comprises a pop-up window event; or
the multiple application clients comprise a battery charging application client and the predefined event corresponding to the battery charging application client comprises a battery charging event in standby state.

8. A method for centralized management of launching multimedia information from a server into areas within displayed interfaces of multiple application clients running in an electronic device, comprising:
determining, by the server, multimedia information to be launched to each application client of the multiple application client based on a predefined launch strategy and a set of multimedia information managed by the server; and
sending the determined multimedia information corresponding to each application client of the multiple application clients, causing each application client of the multiple application clients, upon reception of the determined multimedia information, to display the corresponding multimedia information in at least one of the areas of the displayed interface of each application client,
wherein the server is separate from an application servers associated with the multiple application clients.

9. The method of claim 8, further comprising:
Receiving, by the server, requests to display multimedia information sent by the multiple application clients before determining multimedia information to be launched to each of the multiple application clients based on the predefined launch strategy and the set of multimedia information, wherein each request to display multimedia information is triggered by an occurrence of a predefined event in one of the multiple application clients.

10. The method of claim 8, wherein the determining multimedia information for each application client comprises determining in response to a preset data state, the multimedia information to be launched to the application client based on the launch strategy and the set of multimedia information, wherein the preset data state comprises:
when the launch strategy comprises a list of application clients to which multimedia information could be launched and the list includes the application client; or
when a system time is within a launch time period included in the launch strategy for the application client; or
when an actual total launch frequency of multimedia information for all the multiple application clients is less than a first total maximum launch frequency preset in the launch strategy.

11. The method of claim 8, wherein determining the multimedia information to be launched to each application client comprises:
determining, when the launch strategy comprises specific multimedia information corresponding to the application client, the specific multimedia information from the set of multimedia information as the multimedia information to be launched to the application client; or
obtaining, when the launch strategy comprises multiple pieces of specific multimedia information corresponding to the application client and a second maximum launch frequencies each for each of the pieces of specific multimedia information, an actual launch frequency for each piece of specific multimedia information, wherein the second maximum launch frequency indicates the maximum tolerable launch frequency of the corresponding piece of specific multimedia information, and selecting, when the actual launch frequency of the specific piece of multimedia information is less than the corresponding second maximum launch frequency, the specific piece of multimedia information to be the multimedia information to be launched to the application client; or
obtaining a current weight of each piece of multimedia information in the set of multimedia information, wherein the weight indicates a probability of a corresponding multimedia information being selected, and selecting the multimedia information to be launched to the application client from the set of multimedia information in a descending order of the current weight of each piece of multimedia information.

12. An electronic device, comprising
a memory for storing instructions;
a display screen for displaying interfaces for multiple application clients running on the electronic device; and
a processor configured to:
determine, by a launch management application client running on the electronic device, multimedia information to be launched to each application client of the multiple application clients based on a predefined launch strategy and a set of multimedia information managed by the launch management application client; and
send the corresponding determined multimedia information to each application client of the multiple application clients, causing each application client, upon reception of the corresponding multimedia information, to display the corresponding multimedia information in an area of the displayed interface of each application client.

13. An electronic device, comprising:
a memory for storing instructions;
a display screen for displaying interfaces of multiple application client running on the electronic device; and
a processor configured to:
send a request by each of the multiple application clients to display multimedia information to a launch management application client running in the electronic device or a server upon detection of an occurrence of a predefined event in the application client, wherein the application client corresponds to at least one predefined event and the launch management application client or the server manages launches of multimedia information to the application client; and
display the multimedia information upon reception of the multimedia information sent by the launch management application client or the server in an area within a displayed interface of each of the multiple application clients.

14. A server, comprising:
a memory for storing instructions; and
a processor configured to:
determine multimedia information to be launched to each application client of multiple application clients running on an electronic device based on a predefined launch strategy and a set of multimedia information managed by the server; and
send the corresponding determined multimedia information to each application client of the multiple application clients, causing each application client of the multiple application clients, upon reception of the corresponding multimedia information, to display the corresponding multimedia information in an area of a displayed interface of each application client,
wherein the server is separate from application servers associated with the multiple application clients.
